(19) United States
(12) Patent Application Publication
(10) Pub. No.: US 2013/0037057 A1
(43) Pub. Date: Feb. 14, 2013

(54) MINIMAL ENTRY METHOD AND APPARATUS FOR CLEANING FLUID CONTAINERS

(71) Applicant: Raymond R. O'Quinn, JR., Spring, TX (US)

(72) Inventor: Raymond R. O'Quinn, JR., Spring, TX (US)

(73) Assignee: BAKER HUGHES INCORPORATED, HOUSTON, TX (US)

(21) Appl. No.: 13/207,178

(22) Filed: Aug. 10, 2011

(51) Int. Cl. B08B 9/093; B08B 5/04; B08B 3/08; B08B 3/02

(52) U.S. Cl. 134/10; 134/168 R

(57) ABSTRACT

A system for cleaning a container that includes a cleaner positioned inside the container that includes a spray nozzle, an arm configured to move the nozzle, and a fluid recovery device positioned inside the container. The fluid recovery device may include a return line configured to convey a waste fluid from the container and an injection line. The injection line may add a flow additive internal or external to the return line. The system may also include a supply pump positioned outside the container; and a retrieval pump positioned outside the container.

### FIELD OF THE DISCLOSURE

This disclosure relates to the cleaning of containers used for storing engineered fluids by minimizing human entry to those containers.

### BACKGROUND OF THE DISCLOSURE

The construction, completion, and workover of hydrocarbon producing wells often require a variety of engineered fluids. During drilling of a wellbore, drilling fluids or “muds” may be used to provide wellbore lubrication, to cool the drill bit, to protect against corrosion and to provide a pressure head to maintain formation integrity. Later, during completion operations, frac fluids may be utilized to increase the flow out of subsurface formations. Drilling fluids and frac fluids are merely illustrative of the various fluids that may need to be transported, stored, utilized, and recovered during well construction or completion.

In many instances, the engineered fluids used in these applications include a carrier fluid and an entrained component. For example, a frac fluid may include diesel and sand. Also, a drilling fluid may include water or oil and entrained solids. During use, these engineered fluids may be stored in tanks, pits, and other enclosed or open spaces that will hereafter be referred to as containers. In some instances, these fluids may remain stored for a period sufficient for the entrained material to settle from the carrier fluid.

Conventionally, human personnel enter a fluid containing structure to clean the residual material from the structure surfaces. The present disclosure provides methods and devices for cleaning such containers while minimizing or eliminating need for human entry into those structures.

### SUMMARY OF THE DISCLOSURE

In aspects, the present disclosure provides a system for cleaning a container. The system may include a cleaner positioned inside the container. The cleaner may include a nozzle configured to spray a fluid onto a surface of the container; an arm configured to move the nozzle in a plurality of directions in the container, and a fluid recovery device positioned inside the container. The fluid recovery device may include a return line configured to convey a waste fluid from the container; an injection line in fluid communication with the return line; and at least one connector forming a fluid connection between the injection line and the return line. The system may also include a supply pump positioned outside the container, the supply pump conveying the fluid to the cleaner; and a retrieval pump positioned outside the container, the retrieval pump drawing the waste fluid through the return line using a vacuum pressure.

In aspects, the present disclosure also provides a method for cleaning a container. The method may include positioning a cleaner in the container; positioning a fluid recovery device in the container, the fluid recovery device having an injection line and a return line; applying a cleaning fluid to the interior surface of the tank using the cleaner, the cleaning fluid mixing with a residue to form a waste liquid; conveying the waste liquid out of the tank via the return line by applying a vacuum pressure to the return line using a retrieval pump positioned exterior to the tank; and adding a flow additive to the waste liquid in the return line by using the injection line.

In aspects, the present disclosure further provides a system for cleaning a container that includes a cleaner positioned inside the container. The cleaner may include a nozzle configured to spray a fluid onto a surface of the container, an arm configured to move the nozzle in a plurality of directions in the container, and a fluid recovery device positioned inside the container. The fluid recovery device may include a return line configured to convey a waste fluid from the container and a injection line having an opening dispensing a flow additive external to the return line. The system may also include a supply pump positioned outside the container, the supply pump conveying the fluid to the cleaner, and a retrieval pump positioned outside the container, the retrieval pump drawing the waste fluid through the return line using a vacuum pressure.

Examples of certain features of the disclosure have been summarized rather broadly in order that the detailed description thereof that follows may be better understood and in order that the contributions they represent to the art may be appreciated.

### BRIEF DESCRIPTION OF THE DRAWINGS

For a detailed understanding of the present disclosure, reference should be made to the following detailed description of the embodiments, taken in conjunction with the accompanying drawings, in which like elements have been given like numerals, wherein:

FIG. 1 shows a schematic side view of a top mounted cleaner installed using minimal human entry according to one embodiment according to the present disclosure;

FIG. 2 schematically illustrates a closed loop cleaning system according to one embodiment according to the present disclosure;

FIG. 3 schematically illustrates a portion of a fluid recovery device according to one embodiment according to the present disclosure; and

FIG. 4 schematically illustrates another embodiment of a fluid recovery device according to the present disclosure.

### DETAILED DESCRIPTION

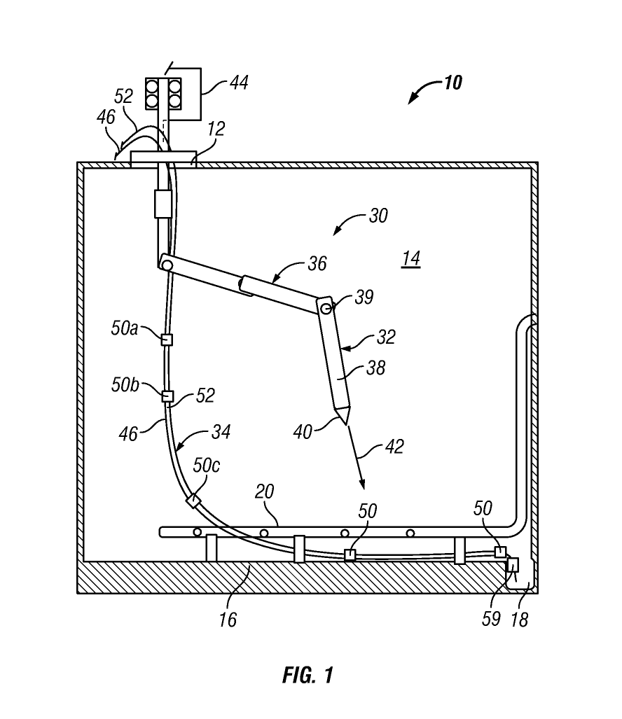

In aspects, the present disclosure relates to systems, methods, and devices that may be employed to minimize or eliminate the need for human personnel to enter a confined area that requires cleaning. Such confined areas include storage tanks and containers found on transport vehicles or vessels used in the oil and gas industry. Referring to FIG. 1, there is schematically shown a side view of an illustrative storage container 10 that may require cleaning. The container 10 may include a hatch or entry 12 at the top or upper wall that provides downward access to an interior space 14. The bottom wall 16 of the container 10 may be inclined to allow fluids to flow to a sump 18. Additionally, the container 10 may include an agitator 20 that may be used to circulate fluid in the container 10.

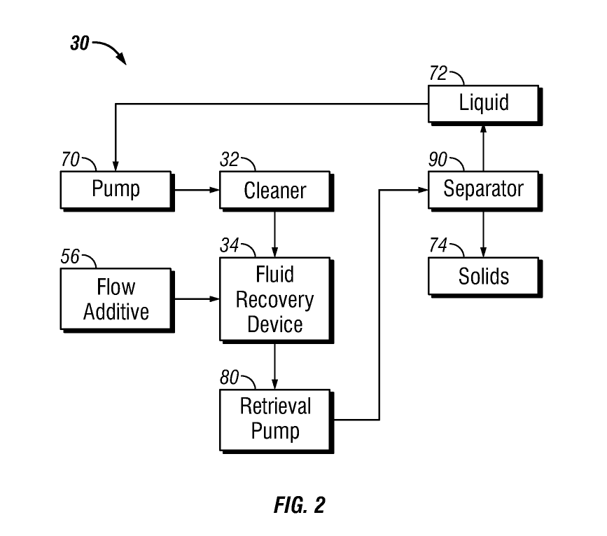

In embodiments of the present disclosure, the interior surfaces of the container 10 (FIG. 1) are cleaned with a modular and transportable cleaning system 30. FIG. 2 functionally depicts the various components of the cleaning system 30. Positioned inside the container are a cleaner 32 and a fluid recovery device 34. The cleaner 32 dispenses a high-velocity fluid stream onto the internal surfaces of the container 10 (FIG. 1) that dislodges solids and residual fluids. The fluid recovery device 34 draws the dispensed fluid and residual materials, or “waste fluids,” out of the container 10 (FIG. 1). Positioned external to the container 10 (FIG. 1) are a supply pump 70, a retrieval pump 80, and a separator 90. The supply pump 70 delivers pressurized cleaning fluid to the cleaner 32 and the retrieval pump 80 applies a vacuum pressure to retrieve the waste fluids out through the fluid recovery device 34. The separator 90 separates the waste fluids from the fluid recovery device 34 into a filtered liquid stream 72 and solids 74. The filtered liquids 72 may be conveyed to the supply pump 70 for reuse.

Referring to FIG. 1, embodiments of the cleaning system 30 may be designed such that human entry is not required for installing either the cleaner 32 or the fluid recovery device 34 into the container 10. The cleaner 32 may include an articulated arm 36 having sections 38. The sections 38 may be interconnected with actuators 39. The actuators 39 may be hydraulic actuators energized by pressurized hydraulic fluid, pneumatic actuators energized by pressurized gas, electric actuators energized by electrical power, etc. At the end of the arm 36 is a nozzle 40 that directs a fluid jet 42 onto the interior surfaces of the container 10. The arm 36 may be configured to move the nozzle 40 along two or more axes (e.g., an x, y, and z axis). A feed line 44 conveys the cleaning fluid from an external source to the nozzle 40. It should be appreciated that the modular nature of the cleaner 32 allows portions of the system 30 to be assembled external to the container 10 and inserted into the container 10 via the entry 12 using suitable devices such as hoists or pulleys.

In accordance with the teachings of the present disclosure, the fluid recovery device 34 may also be designed for installation without human entry into the container 10. As described above, the fluid recovery device 34 draws the waste fluids out of the container 10. Positioning the retrieval pump 80 external to the container 10 leaves only the fluid recovery device 34 to be installed in the container 10. The density or viscosity of the waste fluids contaminants may require a vacuum pressure that is greater than that can be generated by a suitably portable retrieval pump. Thus, as discussed in greater detail below, embodiments of the present disclosure use a flow additive to assist in retrieving waste fluids from the container 10.

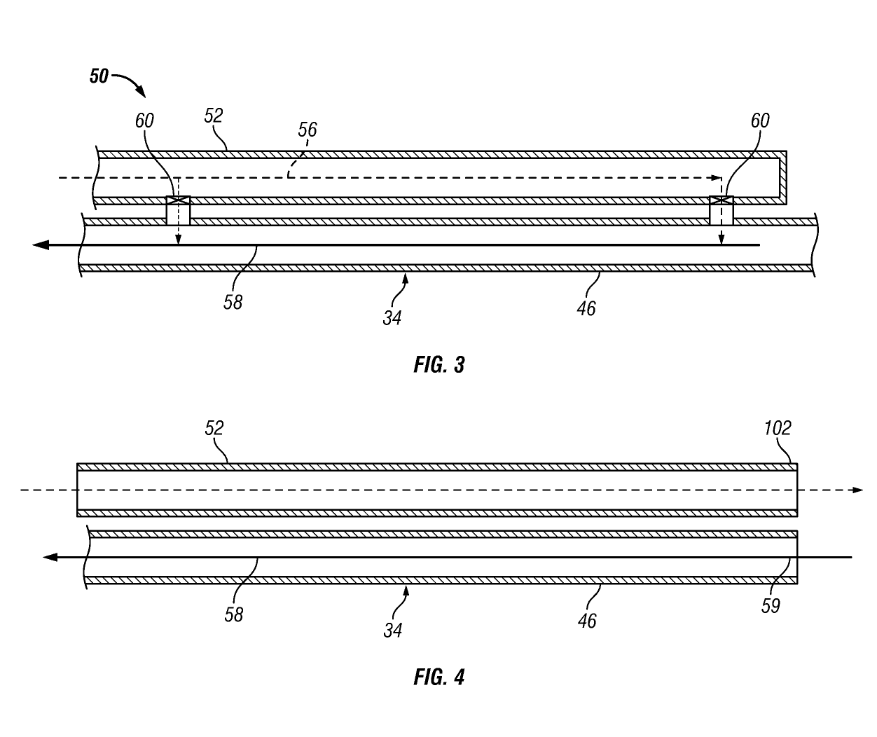

Referring to FIGS. 1 and 3, there is shown one non-limiting example of a fluid recovery device 34 that is configured to add a flow additive to retrieved waste fluids. The fluid recovery device 34 may include a return line 46 that draws waste fluids from the container 10 using vacuum pressure and one or more connectors 50 at which a flow additive 56 may be added to a waste fluid 58 in the return line 46. The injection line 52 may be a flexible hose or other suitable flow line and may inject the flow additive 56 at one or more ports 60. The ports 60 may include flow control devices such as valves that allow uni-directional flow, e.g., from the injection line 52 to the return line 46. The flow additive 56 may be supplied from an external source. Illustrative flow additives include, but are not limited, to air, nitrogen, gases, liquids, and mixtures thereof. The flow additive may also include one or more agents that control a flow-sensitive parameter (e.g., density, viscosity, friction, etc.) to reduce a pressure differential required to flow the waste fluid 58 along the return line 46. Illustrative flow additives include, but are not limited to, thinning or density-reducing agents that are formulated to reduce an effective density of the waste fluid 58, viscosity reducers that reduce a shear strength of the waste fluid 58, and friction reducers that reduce frictional forces along the return line 46.

Prior to use, the cleaning system 30 is transported to a location such as a dock or fluid storage facility in a disassembled state. At the desired location, the cleaner 32 is assembled and inserted into the container 10. Thereafter, the cleaner 32 may be connected to controls and an energy supply (not shown). Once the cleaner 32 is operational, the cleaner 32 may be used to position the fluid recovery device 34. For instance, the fluid recovery device 34 may be inserted into the container 10 until it can be captured and manipulated by the cleaner 32. For such an operation, the cleaner 32 may use specially fitted fingers or clamps. Once captured, an operator may position the inlet of the fluid recovery device 34 at a desired location, such as at or near the sump 18. Thereafter, the remainder of the cleaning system 30 may be assembled. In other embodiments, a separate device such as a hoist or remotely controlled vehicle may be used to appropriately position the fluid recovery device 34.

In one operating mode, the flow additive 56 may be continuously or periodically fed into the injection line 52. The combined waste fluid 58 and the flow additive 56 are drawn via suction pressure through the return line 46. The waste fluid 58 and the flow additive 56 may form a homogenous mixture or may remain separated. In either instance, the net density of the material (or other flow-sensitive parameter) in the return line 46 has been reduced, which facilitates fluid movement using the suction pressure applied to the return line 46. The injection of the flow additive 56 may occur at multiple connectors 50 along the return line 46. In some embodiments, the injection rate may be the same at each connector 50. In other embodiments, the injection rate may be varied at two or more of the connectors 50. Additionally, pressure regulators may be used along the injection line 52 to control the pressure of the flow additive 56.

In another operating mode, the flow additive 56 may be sequentially fed into a series of connectors 50. For example, referring to FIG. 1, the flow additive may be sequentially injected into the connectors 50a-c. The externally applied vacuum force may draw the waste fluid column a height above the connector 50a. Injecting a “slug” of the flow additive into the return line 46 at connector 50a may further move the column of the waste fluid. Next, “slugs” of flow additive are sequentially added at connectors 50a and 50b, respectively, to continue movement of the waste fluid column.

Referring to FIG. 4, there is shown another non-limiting example of a fluid recovery device 34 that is configured to add a flow additive to retrieved waste fluids 58. The fluid recovery device 34 may include a return line 46 that is similar to that shown in FIG. 3. The injection line 52 may be a flexible hose or other suitable flow line and may inject the flow additive 56 at an opening 102. In this embodiment, the flow additive 56 is mixed with the waste fluid 58 before entering the return line 46. As shown, the injection line 52 may be positioned such that the opening 102 is next to an inlet 59 of the return line 46. In other embodiments, the opening 102 may be positioned elsewhere in the container 10 (FIG. 1).

It should be appreciated that treating the waste fluid with a flow additive or some other agent that improves flow characteristics eliminates the need to have a pump or other similar fluid mover inside the container 10. This may be advantageous because such equipment may impose lifting and handling demands that may not be adequately met without having human personnel enter the container 10.

While the foregoing disclosure is directed to the one mode embodiments of the disclosure, various modifications will be apparent to those skilled in the art. It is intended that all variations be embraced by the foregoing disclosure.

We claim:

1. A system for cleaning a container, comprising:
a cleaner positioned inside the container, the cleaner including:
a nozzle configured to spray a fluid onto a surface of the container;
an arm configured to move the nozzle in a plurality of directions in the container,
a fluid recovery device positioned inside the container, the fluid recovery device including:
a return line configured to convey a waste fluid from the container;
an injection line in fluid communication with the return line;
at least one connector forming a fluid connection between the injection line and the return line;
a supply pump positioned outside the container, the supply pump conveying the fluid to the cleaner; and
a retrieval pump positioned outside the container, the retrieval pump drawing the waste fluid through the return line using a vacuum pressure.

2. The system of claim 1, further comprising a source in fluid communication with the injection line, the source being positioned outside the container and configured to supply a flow additive to the injection line.

3. The system of claim 2, wherein the flow additive is one of: (i) a gas, (ii) a liquid, (ii) a liquid-gas mixture.

4. The system of claim 2, wherein the flow additive is formulated to one of: (i) reduce a density of the waste fluid, (ii) reduce a viscosity of the waste fluid, and (iii) reduce friction losses along the return line.

5. The system of claim 1, wherein the at least one connector comprising a plurality of connectors distributed along the return line.

6. The system of claim 1, wherein the cleaner is configured to engage with and manipulate at least a portion of the fluid recovery device.

7. A method for cleaning a container, comprising:
positioning a cleaner in the container;
positioning a fluid recovery device in the container, the fluid recovery device having an injection line and a return line;
applying a cleaning fluid to the interior surface of the tank using the cleaner, the cleaning fluid mixing with a residue to form a waste liquid;
conveying the waste liquid out of the tank via the return line by applying a vacuum pressure to the return line using a retrieval pump positioned exterior to the tank; and
adding a flow additive to the waste liquid in the return line by using the injection line.

8. The method of claim 7, further comprising supplying the flow additive to the injection line using a source positioned outside the container.

9. The method of claim 8, wherein the flow additive is one of: (i) a gas, (ii) a liquid, (ii) a liquid-gas mixture.

10. The method of claim 8, wherein the flow additive is formulated to one of: (i) reduce a density of the waste fluid, (ii) reduce a viscosity of the waste fluid, and (iii) reduce friction losses along the return line.

11. The method of claim 7, further comprising adding the flow additive by using a plurality of connectors distributed along the return line.

12. The system of claim 1, further comprising positioning at least a portion of the fluid recovery device in the container using the cleaner.

13. A system for cleaning a container, comprising:
a cleaner positioned inside the container, the cleaner including:
a nozzle configured to spray a fluid onto a surface of the container;
an arm configured to move the nozzle in a plurality of directions in the container,
a fluid recovery device positioned inside the container, the fluid recovery device including:
a return line configured to convey a waste fluid from the container;
a injection line having an opening dispensing a flow additive external to the return line;
a supply pump positioned outside the container, the supply pump conveying the fluid to the cleaner; and
a retrieval pump positioned outside the container, the retrieval pump drawing the waste fluid through the return line using a vacuum pressure.

14. The system of claim 13, further comprising a source in fluid communication with the injection line, the source being positioned outside the container and configured to supply the flow additive to the injection line.

15. The system of claim 14, wherein the flow additive is a liquid.

16. The system of claim 13, wherein the cleaner is configured to engage with and manipulate at least a portion of the fluid recovery device.
